(19) United States
(12) Patent Application Publication
(10) Pub. No.: US 2021/0031265 A1
(43) Pub. Date: Feb. 4, 2021

(54) Selective Electrochemical Machining of Workpieces and Systems for Producing a Workpiece

(71) Applicant: Siemens Aktiengesellschaft, München (DE)

(72) Inventors: Jens Dahl Jensen, Berlin (DE); Manuela Schneider Schneider, Berlin (DE); Gabriele Winkler, Berlin (DE)

(73) Assignee: Siemens Aktiengesellschaft, München (DE)

(21) Appl. No.: 17/045,915

(22) PCT Filed: Mar. 21, 2019
(86) PCT No.: PCT/EP2019/057046

§ 371 Date: Oct. 7, 2020

(30) Foreign Application Priority Data
Apr. 10, 2018 (EP) 18166471.5

(51) Int. Cl. B22F 3/105; B33Y 10/00

(52) U.S. Cl. CPC B22F 3/1055; B33Y 80/00; B33Y 10/00

(57) ABSTRACT

Various embodiments include a device for the selective electrochemical machining of workpieces comprising: a machining head equipped with an electrolyte transmitter; and a supply channel for an electrolyte. The electrolyte transmitter is arranged in an interior of the supply channel and protrudes through an outlet opening of the supply channel to form a machining surface for the workpiece. The electrolyte transmitter comprises a cylinder arranged movably in the supply channel axially displaceable in the outlet opening.

### CROSS-REFERENCE TO RELATED APPLICATIONS

This application is a U.S. National Stage Application of International Application No. PCT/EP2019/057046 filed Mar. 21, 2019, which designates the United States of America, and claims priority to EP Application No. 18166471.5 filed Apr. 10, 2018, the contents of which are hereby incorporated by reference in their entirety.

### TECHNICAL FIELD

The present disclosure relates to electrochemical machining. Various embodiments may include devices for the selective electrochemical machining of workpieces, having a machining head equipped with an electrolyte transmitter and a supply channel for an electrolyte, as well as systems for the additive manufacturing of a workpiece with a holder for the workpiece.

### BACKGROUND

Devices for selective electrochemical machining are known for example from DE 10 2015 201 080 A1. According to this, electrochemical machining may comprise removing material from the surface of a metal component. For example, this becomes necessary if a component of which the surface quality is not adequate for the intended application has been created by additive manufacturing. The device for selective electrochemical machining can then be used for the purpose of electrochemically re-machining the component, at least at the points that are critical for use. The restricted guidance of the machining head allows specific geometries to be created, with electrolyte transmitters adapted to this geometry, such as for example sponges or brushes.

### SUMMARY

The teachings of the present disclosure include devices for selective electrochemical machining with which a comparatively universal and precise machining of workpieces is possible, in particular of workpieces produced by means of additive manufacturing. For example, some embodiments include a device for the selective electrochemical machining of workpieces, having a machining head (11), which is equipped with an electrolyte transmitter (16) and a supply channel (22) for an electrolyte, characterized in that the electrolyte transmitter (16) is arranged in the interior of the supply channel (22) and made to protrude through an outlet opening (24) of the supply channel to form a machining surface (15) for the workpiece; and in that the electrolyte transmitter (16) is cylindrical and is arranged movably in the supply channel (22) in such a way that it can be displaced axially in the outlet opening (24).

In some embodiments, the electrolyte transmitter (16) comprises a rolled nonwoven (34), in particular a rolled fiber-reinforced nonwoven.

In some embodiments, the supply channel (22) is cylindrically designed and the electrolyte transmitter (16) extends coaxially in the supply channel.

In some embodiments, particles (37) of a harder material in comparison with the electrolyte transmitter (16) are provided in the electrolyte transmitter (16).

In some embodiments, the machining head (11) comprises a tube (21), in particular of glass, in which the supply channel (22) extends.

In some embodiments, the outlet opening (24) is formed by a tapering tube end (23) of the tube (21).

In some embodiments, the supply channel has at least two feeding-in points (32) for different coating materials, one of which may in particular comprise particles.

In some embodiments, an extraction opening (29) of an extraction channel (30) is arranged at the outlet opening (24).

In some embodiments, the extraction opening (29) extends in an annular manner around the outlet opening.

In some embodiments, a flushing opening (33) of a flushing channel (31) is arranged at the outlet opening (24).

In some embodiments, the machining head (11) is equipped with a vibration actuator, in particular a piezo actuator (38).

In some embodiments, the machining head (11) is mechanically connected to a guiding device (12).

As another example, some embodiments include a system for the additive manufacturing of a workpiece (14) with a holder (42) for the workpiece (14), characterized in that a device as claimed in one of the preceding claims is arranged in the system.

In some embodiments, it is designed for carrying out a powder-bed-based additive manufacturing process.

### BRIEF DESCRIPTION OF THE DRAWINGS

The exemplary embodiments explained herein show various aspects of the teachings. Various components of the embodiments each represent individual features of the teachings which may be considered independently of one another and which each also develop the teachings independently of one another or in a combination other than that shown. Furthermore, further features of the teachings which have already been described can also be added to the described embodiments.

In the drawings:

FIG. 1 shows an exemplary embodiment of a device incorporating teachings of the disclosure in section,

FIG. 2 shows a nonwoven with which an electrolyte transmitter can be produced for an exemplary embodiment of the device incorporating teachings of the present disclosure, and

FIG. 3 shows an exemplary embodiment of the system incorporating teachings of the present disclosure as a detail of a process chamber for the additive manufacturing of a component.

### DETAILED DESCRIPTION

The teachings of the present disclosure include various embodiments in which the electrolyte transmitter is arranged in the interior of the supply channel and made to protrude through an outlet opening of the supply channel to form a machining surface for the workpiece. Consequently, the outlet opening serves at the same time for metering the electrolyte, but also for guiding through the electrolyte transmitter, which in principle is arranged in the interior of the supply channel and only a small part of which projects out of the outlet opening. This part among other things forms the machining surface for the workpiece, i.e. that surface that comes into contact with the workpiece and, as a consequence, allows electrochemical machining of the workpiece with the aid of the electrolyte transmitted by the electrolyte transmitter. Machining of the workpiece may comprise both electrochemical coating and electrochemical decoating. This depends on several factors.

On the one hand, coating or decoating may be achieved by selecting a suitable electrolyte. If the right electrolyte is chosen, this is also possible currentlessly by electrochemical means. Another possibility is to apply a voltage both to the electrolyte transmitter and to the workpiece. Depending on the polarity of this voltage, the workpiece can be coated or decoated (more to follow on this).

In some embodiments, the electrolyte transmitter is cylindrical and is arranged movably in the supply channel in such a way that it can be displaced axially in the outlet opening. This makes it possible that, in the event of wear, the electrolyte transmitter can be moved in the supply channel in order to be readjusted through the outlet opening. In this way, the wear of the electrolyte transmitter is compensated. As a result, longer lifetimes of the electrolyte transmitter or longer maintenance-free operation of the machining head of the device are possible. This may also have advantageous effects on the cost-effectiveness of the process.

In some embodiments, he electrolyte transmitter in the supply channel may be designed in a way similar to a felt tip pen. This means that the machining surface of the electrolyte transmitter can be kept very small, that is to say for comparison is formed in a way corresponding to the tip of the felt tip pen. As a result, locally very limited application of the electrochemical machining to the workpiece is possible. This is in keeping with the selectivity of an additive manufacturing process, such as laser melting or electron-beam melting. Individually produced regions of the workpiece can be specifically acted upon by the electrolyte transmitter, allowing the exact feeding of the electrolyte transmitter to the surface of the component that is to be machined.

In some embodiments, the electrolyte transmitter comprises a rolled nonwoven, in particular a rolled fiber-reinforced nonwoven. The nonwoven forms the capillaries that are required for conducting the electrolyte. This is a semifinished product that can be obtained at low cost and, by rolling, can be made into a kind of felt tip pen nib, specifically the electrolyte transmitter.

In some embodiments, an electrode for the transmission of an electrode current for electrochemical machining is incorporated in the rolled nonwoven. For example, the nonwoven may be wound around a rod-shaped electrode, which is then arranged in the central medial axis of the cylindrically formed electrolyte transmitter. In some embodiments, a number of wires are wound into the electrolyte transmitter as electrodes. This improves the distribution of current within the electrolyte transmitter, a large surface for the transmission of the electrical current being available with a comparatively small expenditure of material for the electrodes.

In some embodiments, the supply channel is cylindrically designed and the electrolyte transmitter extends coaxially in the supply channel. On the one hand, as a result the electrolyte can be supplied uniformly to the electrolyte transmitter, since the latter can be flowed around completely by the electrolyte. Furthermore, such a device has a comparatively simple structural design, and can therefore be easily produced. Lastly, the axial displacement of the electrolyte transmitter in the event of wear can be achieved in an easy way by the outlet opening.

In some embodiments, particles of a harder material in comparison with the electrolyte transmitter are provided in the electrolyte transmitter. These particles may for example consist of a hard material. Customary substances such as corundum, diamond and others are suitable for this. The particles reduce the wear of the electrolyte transmitter when it rubs over the surface to be machined. In particular in the case of machining involving removal, this also assists the removal process, because the surface can be mechanically distressed specifically by the particles. The particles are also harder than the substance to be machined, in order that a re-machining of the surface with additional material removal is made possible.

In some embodiments, the machining head comprises a tube, in particular of glass, in which the supply channel extends. Being made from a tube has effects on a simple geometry of the machining head, so that it can be produced at low cost. If it is in particular produced from glass, glass is inert for most electrolytes that are used, and is consequently not involved in the reaction. A transparent glass also additionally allows a visual check on the machining process, it being possible for example to check at any time for the occurrence of clumps forming in particles to be deposited in the supply channel and also the state of the electrolyte transmitter.

In some embodiments, the outlet opening is formed by a tapering tube end of the tube. This can be produced very easily for example in glass. The outlet opening is then adapted in cross section to the electrolyte transmitter, thereby achieving the effect that leakage at this point can be kept low and the delivered electrolyte is only delivered through the capillaries present in the electrolyte transmitter.

In some embodiments, the supply channel has at least two feeding-in points for different coating materials. Apart from the coating materials, which may initially consist of the ions dissociated in the electrolyte, it is possible, in particular, to use particles which can be incorporated in a layer forming. These are then also delivered through the electrolyte transmitter, the particles having to be of a size that allows them to pass through the pores/capillaries formed by the electrolyte transmitter. It is also possible in particular to select nanoparticles, with which layers having particular property profiles can be advantageously created.

In some embodiments, an extraction opening of an extraction channel is arranged at the outlet opening. The extraction channel consequently makes it possible by way of the extraction opening that, after carrying out the coating process, the electrolyte that has left the electrolyte transmitter can be removed again from the machined surface. This electrolyte can subsequently be passed on for further use and furthermore does not impair the qualities of the component at points at which re-machining is not provided.

In some embodiments, the extraction opening is formed in an annular manner around the outlet opening. This allows an extraction of the electrolyte independently of in which direction it flows after leaving the electrolyte transmitter. This may change in the case of the component for example because the surface is arranged at different spatial inclinations during a re-machining operation.

In some embodiments, a flushing opening of a flushing channel is arranged at the outlet opening. With the flushing channel, a flushing liquid can be applied to the surface, in order for example to remove remains of electrolyte after machining. As a result, in particular an electrochemical machining process that is in progress but is no longer desired can be interrupted.

In some embodiments, the machining head is equipped with a vibration actuator, in particular a piezo actuator. As a result, the machining head is made to vibrate, the vibrations being transferred to the surface to be machined. This brings about a continual relative movement between the component to be machined and the machining head, whereby the machining process is assisted. In particular, decoating in which an electrolyte transmitter that additionally contains hard particles is used can be assisted. These particles then act like an abrasive, which as a result of the vibration rubs over the surface of the component with a relative movement, and consequently brings about a mechanical removal of material. In the case of coating, the vibration may also be used at the beginning of a coating operation for the purpose that, by means of the particles, contaminants or a passivation layer is/are removed from the component to be coated. In some embodiments, there is a flushing liquid with which subsequent cleaning of the surface to be machined can take place.

In some embodiments, the machining head may be mechanically connected to a guiding device. This guiding device may be for example a robot arm. Another possibility is an X-Y guidance by means of guide rails and a suitable drive, it then being possible for the machining head to be moved in an X-Y plane. In particular in the case of additive manufacturing of components, this may be of advantage, since the layers of the component that are produced are likewise horizontally aligned. As a result, it is also possible for example in a step between the production of two layers of the component to obtain an electrochemical machining of the layer just produced.

Furthermore, the aforementioned object is achieved by the system for the additive manufacturing of a workpiece, a holder for the workpiece being provided in this system. The workpiece is in this case the component to be machined. In some embodiments, a device is arranged in the system in the way described above and, as already previously described, can thus be integrated in the process for producing the workpiece. As a result, the quality of the components produced can be improved already during production in the additive manufacturing system.

In some embodiments, the system is designed for carrying out a powder-bed-based additive manufacturing process. This may be electron-beam melting, laser melting or laser sintering. The components, which are produced here in a powder bed, can then be re-machined. Immediate extraction of the electrolyte also advantageously has the effect that the electrolyte does not flow off into the powder bed.

Further details of the invention are described below on the basis of the drawings. Elements of the drawing that are the same or corresponding are respectively provided with the same reference signs and are only explained more than once if there are differences between the individual figures.

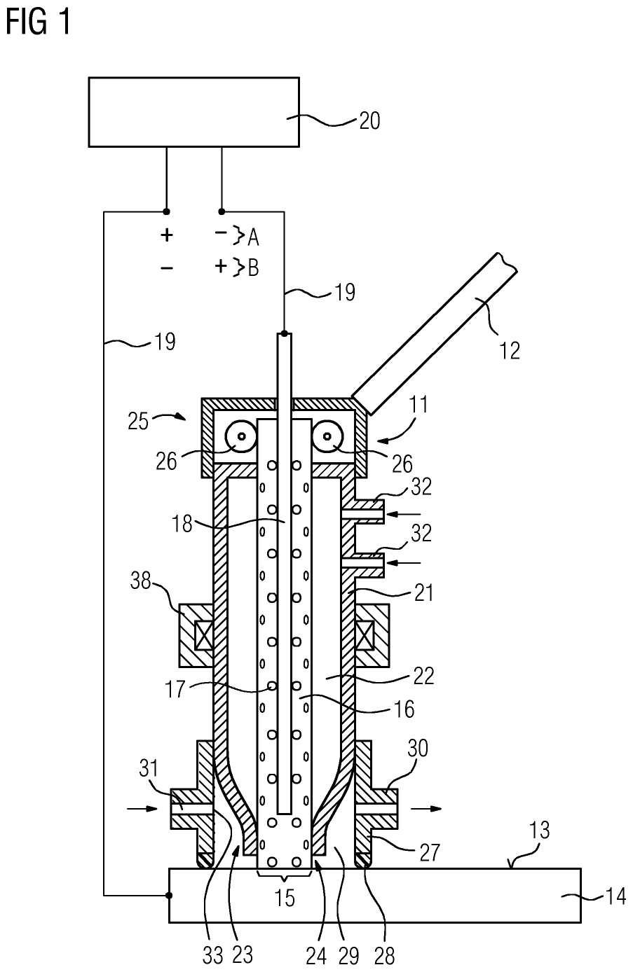

A device for selective electrochemical machining according to FIG. 1 has a machining head 11, which is fastened to a guiding device 12. This may be part of a robot arm, this robot arm being programmable by a controller that is not shown. With the guiding device 12, the machining head 11 can be lowered onto the surface of a workpiece 14, the machining of the surface 13 being performed by a machining surface 15 of an electrolyte transmitter 16.

The electrolyte transmitter 16 is part of the machining head 11. The electrolyte transmitter 16 is cylindrically designed. A circular-cylindrical form of the electrolyte transmitter is shown in FIG. 1, but any other cylindrical form is also conceivable. The word “cylindrical” should be understood here in the broadest sense of its meaning. This means that other forms, for example prisms, are also covered by this term.

The electrolyte transmitter according to FIG. 1 is formed from a material with pores 17, which form an open-pore system, and consequently a capillary channel system for conducting the electrolyte. The open-pore material may be for example a sponge. Formed in the interior of the sponge is a rod-shaped first electrode 18. The second electrode is formed by the workpiece 14 itself. Contacting of the two electrodes can be performed by schematically indicated electrical lines 19, these being connected to a controllable voltage source 20.

The voltage source 20 controls the electrochemical processes of the machining by setting the electrochemical machining parameters that may be specified for coating and decoating of the surface 13. Therefore, the two cases A and B are depicted in FIG. 1. Case A serves for removing material from the workpiece 14, this workpiece being positively charged as an anode, and the electrode 18 in the electrolyte transmitter 16 being negatively charged and acting as a cathode. Case B serves for coating a material which is in an ionized state in the electrolyte, the electrode 18 being positively charged and the workpiece 14 being negatively charged.

The machining head is designed as follows. It has a tube 21, which is cylindrically formed and in the interior forms a supply channel 22. This supply channel is cylindrical, the electrolyte transmitter 16 being arranged coaxially with the supply channel 22. The tube 21 has on the side of the workpiece 14 a concentrically tapering tube end 23, which forms an outlet opening 24 for the electrolyte transmitter 16. Through this outlet opening 24, the electrolyte transmitter 16 can be pushed out axially when it is mechanically worn. For this, a re-adjusting device 25 with transporting wheels 26 is formed (a drive is not shown).

Also formed at the tube end 23 is a sleeve 27, which is placed with a sealing lip 28 onto the surface 13 of the workpiece 14. As a result, an annular extraction opening 29 is formed, surrounding the tube end 23 in an annular manner. Electrolyte that is located on the surface 13 can in this way be extracted, this being performed by way of an extraction channel 30. In addition, a flushing agent may be filled into the annular space of the sleeve by way of a flushing channel 31 with a flushing opening 33 and extracted again by way of the extraction channel 30. This also accomplishes a cleaning of the surface 13 as and when required. Moreover, two feeding-in points 32 for the electrolyte are provided on the tube 21, by way of which the electrolyte and for example particles dispersed in a liquid, in particular the electrolyte itself, can be fed into the supply channel 22. The particles can then in the case of coating be deposited by the machining device in the layer.

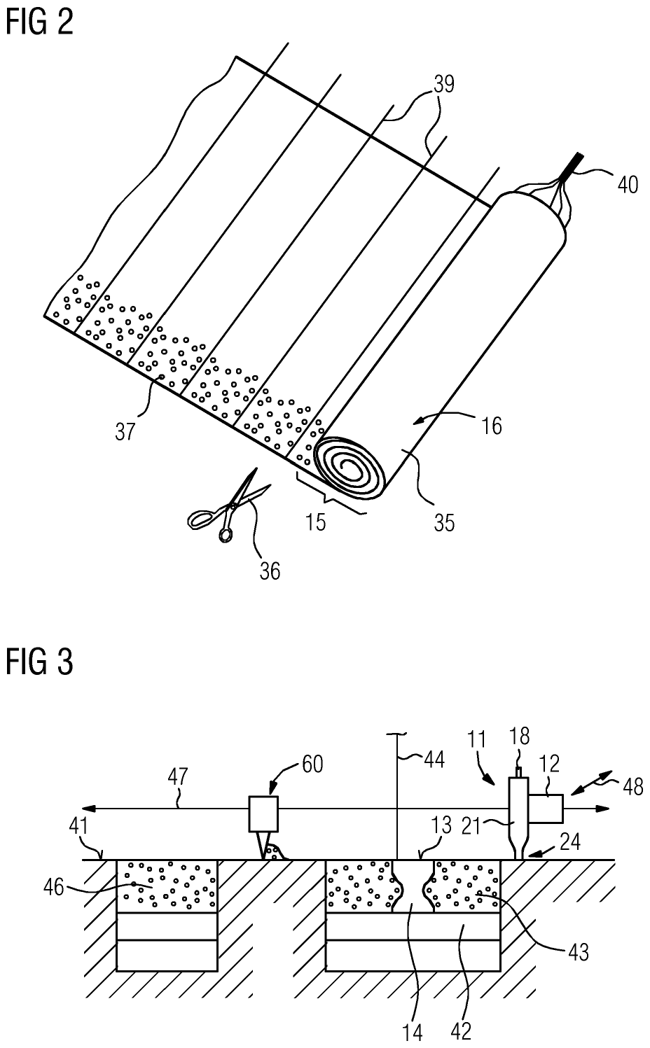

In FIG. 2 it is shown that the electrolyte transmitter 16 can also be produced from a nonwoven 34. This is rolled up to form a roll 35 and, when this roll 35 has reached the required diameter, cut to length by a separating device 36. The nonwoven may for example consist of a glass fiber mat.

In order to reduce the wear of the machining surface 15, hard material particles 37 may be incorporated in the nonwoven. In particular in the case of a workpiece being machined in a way involving removal, these also assist the removal of material by abrasive stress. For this purpose, the machining head 11 may also be made to vibrate, which may be performed for example by a piezo actuator 38 shown in FIG. 1. Furthermore, instead of a central electrode, as shown in FIG. 1, a multiplicity of wires 39 may also be wound into the nonwoven. As shown in FIG. 2, after the cutting to length of the roll, these wires may be brought together to form a conductor 40 (for example by twisting).

In FIG. 3, the bottom 41 of a process chamber of an additive manufacturing system, for example for selective laser melting, is shown. A holder 42 consists of a building platform for the component 14, which is produced in a powder bed 43 by fusing the powder by a laser beam 44. The holder 42 is in this case lowered layer by layer, a metering device 45 (doctor blade) distributing material from a powder store 46 on the powder bed 43.

The metering device 45 and the machining head 11 can be displaced in the directions of the arrows indicated (X direction 47, Y direction 48). As a result, the powder bed can be supplied with fresh powder and machining with the machining head can be carried out at any time at any desired point of the powder bed, that is to say also on the currently shown layer of the component 14. As a result, for example problems with the quality of the surface finish can be corrected by removal of excess material. This may help for example to eliminate the manufacturing effect of a so-called material elevation, which occurs if, on account of a reduced removal of heat into the component already produced, the melt bath becomes too large during laser melting or electron-beam melting.

What is claimed is:

1. A device for the selective electrochemical machining of workpieces, the device comprising:
a machining head equipped with an electrolyte transmitter; and
a supply channel for an electrolyte;
wherein the electrolyte transmitter is arranged in an interior of the supply channel and protrudes through an outlet opening of the supply channel to form a machining surface for the workpiece; and
the electrolyte transmitter comprises a cylinder arranged movably in the supply channel axially displaceable in the outlet opening.

2. The device as claimed in claim 1, wherein the electrolyte transmitter comprises a rolled nonwoven.

3. The device as claimed in claim 1, wherein:
the supply channel comprises a cylindrical channel; and
the electrolyte transmitter extends coaxially in the supply channel.

4. The device as claimed in claim 1, wherein the electrolyte transmitter comprises additional particles of a harder material in comparison with the electrolyte transmitter.

5. The device as claimed in claim 1, wherein the machining head comprises a tube through which the supply channel extends.

6. The device as claimed in claim 5, wherein an outlet opening is formed by a tapering end of the tube.

7. The device as claimed in claim 1, wherein the supply channel has at least two feeding-in points for different coating materials.

8. The device as claimed in claim 1, further comprising an extraction opening of an extraction channel arranged at the outlet opening.

9. The device as claimed in claim 8, wherein the extraction opening extends annularly around the outlet opening.

10. The device as claimed in claim 1, further comprising a flushing opening of a flushing channel arranged at the outlet opening.

11. The device as claimed in claim 1, wherein the machining head comprises a vibration actuator.

12. The device as claimed in claim 1, wherein the machining head is mechanically connected to a guiding device.

13. A system for the additive manufacturing of a workpiece, the system comprising:
a holder for the workpiece;
a machining head equipped with an electrolyte transmitter; and
a supply channel for an electrolyte;
wherein the electrolyte transmitter is arranged in an interior of the supply channel and protrudes through an outlet opening of the supply channel to form a machining surface for the workpiece; and
the electrolyte transmitter comprises a cylinder arranged movably in the supply channel axially displaceable in the outlet opening.

14. The system as claimed in claim 13, wherein the system carries out a powder-bed-based additive manufacturing process.
